(19) United States
(12) Patent Application Publication
(10) Pub. No.: US 2005/0286214 A1
(43) Pub. Date: Dec. 29, 2005

(54) Electronic device with protection function

(75) Inventor: Chyi-Nan Chen, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/137,362

(22) Filed: May 26, 2005

(30) Foreign Application Priority Data
Jun. 25, 2004 (TW) 093118633

(51) Int. Cl. G06F 1/16

(52) U.S. Cl. 361/681; 312/223.2

(57) ABSTRACT

An electronic device with protection function comprises a first housing, a display module and a second housing. In this case, the display module has a display area and at least one portion of the display module is disposed in the first housing. The second housing has a transparent area and connects with the first housing. The transparent area covers the display area.

### BACKGROUND OF THE INVENTION

1. Field of Invention

The invention relates to an electronic device with protection function and, in particular, to an electronic device having a closed computer front bezel for providing protection function.

2. Related Art

In recent years, people become more and more reliant on the electronic products in life. As the technology changes with each passing day, consumers continue to demand that electronic products such as electronic devices are cheaper on price, moreover, have distinguishing features and a lasting use. Regarding to the computer development from the heavy desktop computer to a thin liquid crystal computer, which occupies less space, proves the manufacturers of the electronic products always make the effort to think about how to match the requirements of consumers.

With reference to FIG. 1, a liquid crystal display 1 comprises a front bezel 12, a back plate 11 and a display module 13. In this case, the display module 13 is accommodated in the back plate 11. The liquid crystal display 1 is assembled completely by way of connecting the front bezel 12 and the back plate 11 where a plurality of hooks 121 of the front bezel 12 buckled into a plurality of concaves 111 of the back plate 11 from top to bottom (is indicated along the arrowhead). The conventional front bezel 12 has an opening, the area of which is substantially equal to the area of display area of the display module 13. As the opening structure of the front bezel 12 exposes the display module 13 directly, user's improper press or touch is likely to reduce the product life of the liquid crystal display 1.

Therefore, according to the above-mentioned problems, it is a subjective to provide an electronic device having a structure for providing protection function and then significantly reduces the damage rate of a computer monitor.

### SUMMARY OF THE INVENTION

In view of the foregoing, the invention is to provide an electronic device having a closed computer front bezel for protecting the display area.

To achieve the above, an electronic device with protection function comprises a first housing, a display module and a second housing. In this invention, the display module has a display area and at least one portion of the display module is disposed in the first housing. The second housing having a transparent area connects with the first housing. Wherein, the transparent area covers the display area.

As mentioned above, an electronic device with protection function of the invention is by way of the transparent area of the second housing covers the display area of the first housing. As the second housing is a closed bezel made of acrylic material with hardening treatment, the second housing can effectively protect the display module inside the first housing from exposing directly so as to further lower the damage rate of the display module.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional liquid crystal display;

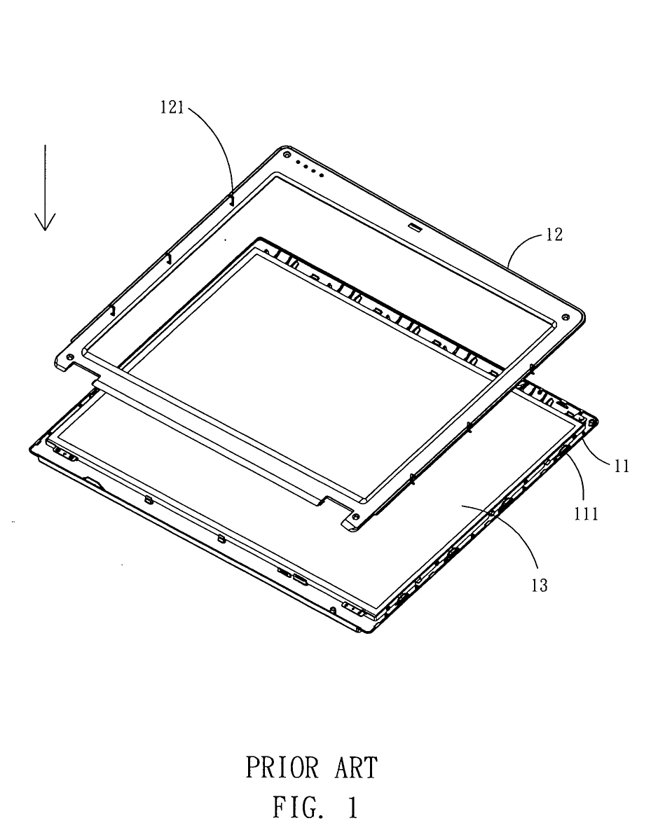

FIG. 2 is a schematic view showing an electronic device with protection function according to a preferred embodiment of the invention;

FIG. 3 is an exploded view showing an electronic device with protection function according to a preferred embodiment of the invention;

FIG. 4 is a sectional partial enlarged view showing the structure of an electronic device with protection function shown in FIG. 2 along the dotted line A-A.

FIG. 5 is a schematic view showing the motion of the second housing and the first housing of an electronic device with protection function for separating according to a preferred embodiment of the invention; and

FIG. 6 is a schematic view showing an electronic device composed of the first housing and the second housing according to a preferred embodiment of the invention.

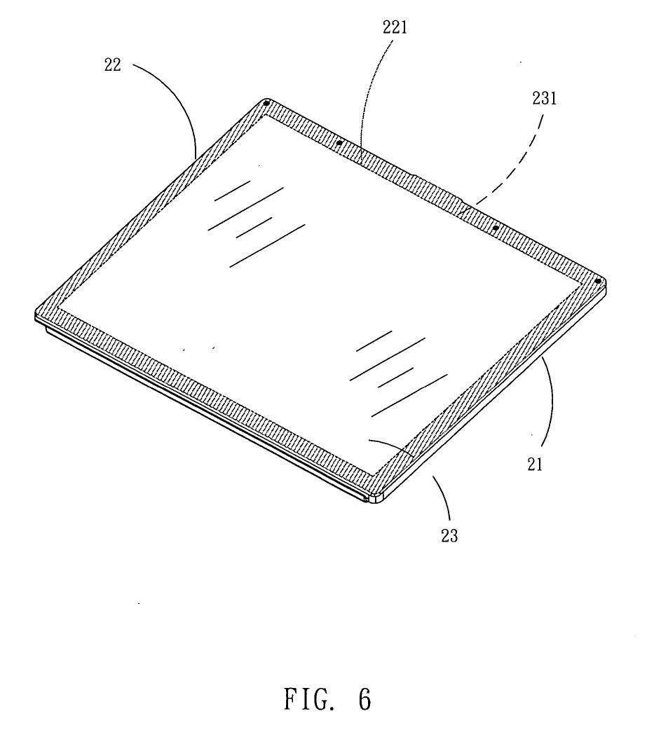

### DETAILED DESCRIPTION OF THE INVENTION

The present invention will be apparent from the following detailed description, which proceeds with reference to the accompanying drawings, wherein the same references relate to the same elements.

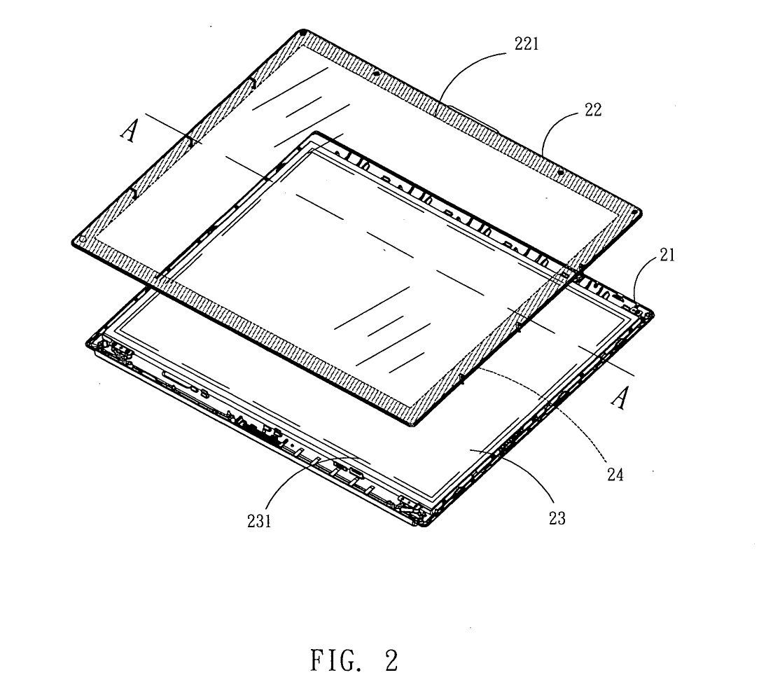

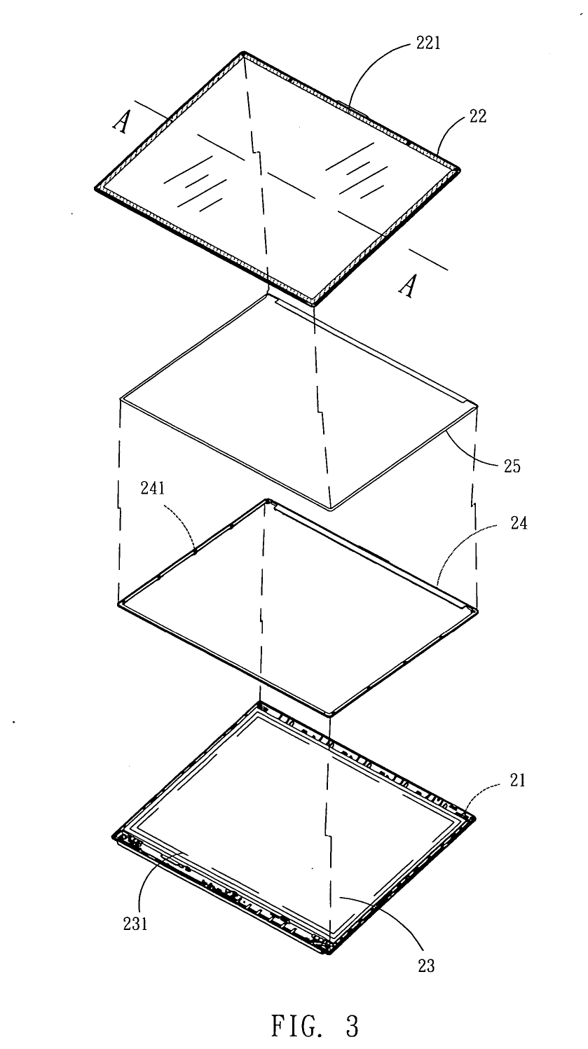

With reference to FIG. 2 and FIG. 3, an electronic device 2 according to the embodiment of the invention having protection function comprises a first housing 21, a display module 23 and a second housing 22. The display module 23 has a display area and at least one portion of the display module 23 is disposed in the first housing 21. The second housing 22 has a transparent area, which covers the display area 231 of the display module 23. In the present embodiment, the display module 23 is a liquid crystal display module.

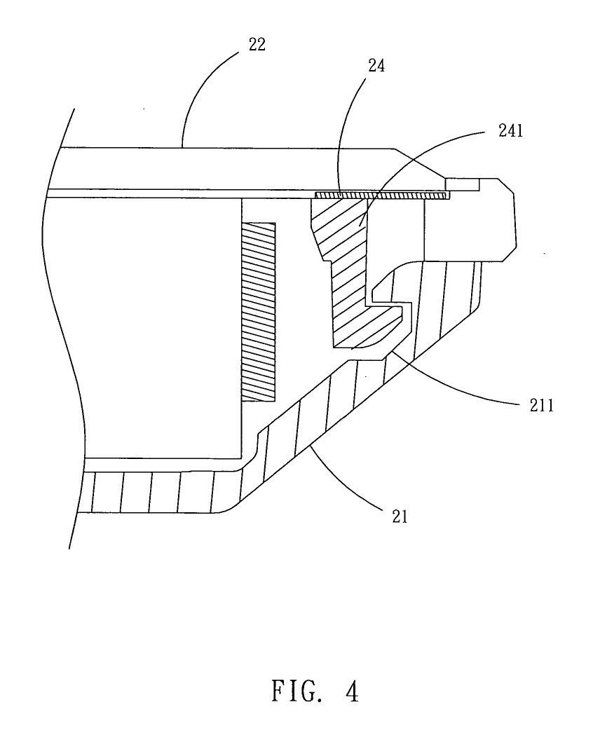

With reference to FIG. 2 and FIG. 3, the electronic device 2 further comprises a frame 24, a side of which connects to the second housing 22. Additionally, the electronic device 2 further comprises a binding element 25, which binds the frame 24 and the second housing 22. In this case, the binding element 25 can be at least one selected from lamination glue, dispensing glue or epoxy glue. With reference to FIG. 4, it is a sectional partial enlarged view shown in FIG. 2 along the dotted line A-A. The first housing 21 has at least one first connection part 211 and the frame 24 has at least one second connection part 241. The first connection part 211 connects with the second connecting part 241. As showing in FIG. 4, the first connection part 211 is a concave and the second connection part 241 is a hook. The hook buckles into the concave for connecting the frame 24 and the first housing 21 with each other. Therefore, the second housing 22 connects the first housing 21 via the frame 24, which is adhered to the second housing 22.

The second housing 22 is a transparent bezel made of acrylic material with hardening treatment. Therefore, the second housing 22 has protection against static electricity and abrasion. Alternatively, the second housing 22 also can be made of at least one selected from glass and transparent plastic. Thus, after the second housing 22 and the first housing 21 are assembled, the light emitted from the display module 23 passes the transparent area 221 of the second housing 22 into the field of user's vision. In this case, the area of the transparent area 221 is substantially equal to the area of the display area 231 of the display module 23, which is disposed in the first housing 21.

For understanding the present invention easily, below an embodiment is taken as an example to illustrate the assembly process of putting the electronic device with the monitor protection function according to the embodiment of the invention into practice.

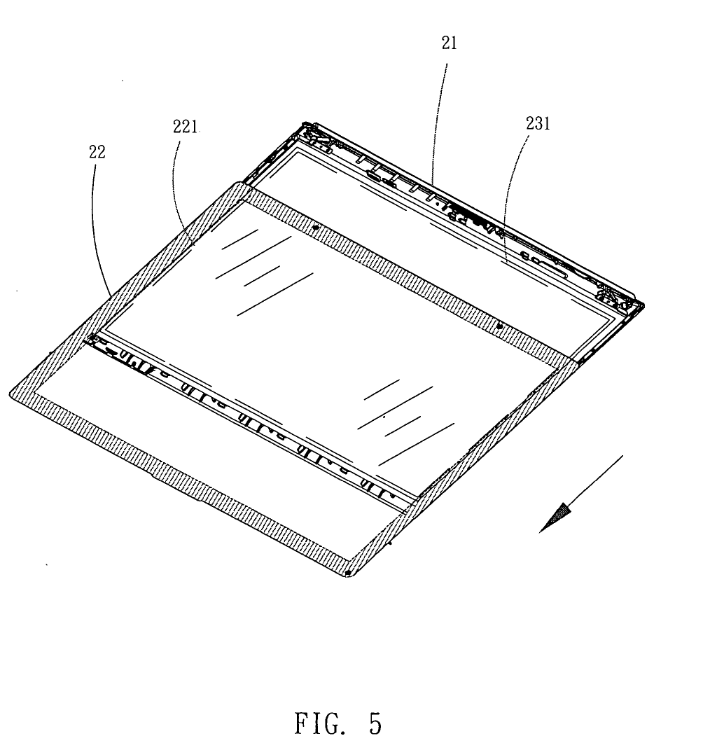

In the present embodiment, the second housing 22 is a transparent bezel made of acrylic in addition to process hardening treatment for protecting it from scraping and grinding. Moreover, it is available to print the pattern of laser label or stick the label on the second housing 22 that makes the appearance of the bezel more artistic. Then, the binding element 25 is fixed on the specific location of the second housing 22 to bind a side of the frame 24. Finally, a plurality of the second connection parts 241 of the frame 24 and a plurality of the first connection parts 211 of the first housing 21 are connected by the mechanism of hook and concave locked with each other. Besides, when the electronic device 2 with the monitor protection function needs to be taken apart, moving the second housing 22 to unlock the second connection part 241, where the second connection part 241 is the hook and the first connection part 211 is the concave, so that the second housing 22 can be separated easily from the first housing 21 by way of sliding the slot from front to back (as is shown in FIG. 5).

In conclusion, the electronic device according to the embodiment of the invention having the monitor protection function consists of the second housing, which is a closed transparent bezel, assembled with the first housing in which the display module is set. As the transparent area of the second housing covers the display area of the display module, the second housing, which is a closed bezel, can protect the display area of the display module from exposing outside directly and further avoid destroying the display module in case of users' improper operation. In addition, due to the hook structure of the frame connected with the second housing, it is easy to separate the first housing and the second housing by way of unlocking the hook and concave, which is set on the first housing, when the electronic device needs to be taken apart.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. An electronic device with protection function, comprising:
a first housing;
a display module having a display area, wherein at least one portion of the display module is disposed in the first housing; and
a second housing having a transparent area and connecting with the first housing, wherein the transparent area covers the display area.

2. The electronic device of claim 1, further comprising a frame, wherein a side of the frame connects to the second housing.

3. The electronic device of claim 2, wherein the first housing has at least one first connection part, the frame has at least one second connection part, and the first connection part connects with the second connection part.

4. The electronic device of claim 2, further comprising a binding element binding the frame and the second housing.

5. The electronic device of claim 3, wherein the first connection part is a concave and the second connection part is a hook.

6. The electronic device of claim 5, wherein when the second housing is moved, the concave and the hook are unlocked for separating the second housing and the first housing.

7. The electronic device of claim 4, wherein the binding element is at least one selected from lamination glue, dispensing glue and epoxy glue.

8. The electronic device of claim 1, wherein the area of the transparent area is substantially equal to the area of the display area of the display module.

9. The electronic device of claim 1, wherein the display module is a liquid crystal display module.

10. The electronic device of claim 1, wherein the second housing is made of at least one selected from acrylic, glass and plastic.
